(19) United States
(12) Patent Application Publication
(10) Pub. No.: US 2015/0254195 A1
(43) Pub. Date: Sep. 10, 2015

(54) METHOD AND APPARATUS FOR WIRELESS COMMUNICATION

(71) Applicant: Samsung Electronics Co., Ltd., Gyeonggi-do (KR)

(72) Inventor: Mark G. Rison, Cambridge (GB)

(73) Assignee: Samsung Electronics Co., Ltd.

(21) Appl. No.: 14/547,813

(22) Filed: Nov. 19, 2014

Related U.S. Application Data
(60) Provisional application No. 61/948,886, filed on Mar. 6, 2014.

(51) Int. Cl. G06F 13/24

(52) U.S. Cl. CPC G06F 13/24

(57) ABSTRACT

A method and apparatus for communication over a wireless medium is provided. The method includes transmitting a signal over the wireless medium, the signal including at least one frame formatted for interpretation by a first device and a second device; and interrupting a transmission function of at least one of the first device and the second device based on an interpretation of the at least one frame.

### PRIORITY

This application claims priority under 35 U.S.C. §119(e) to U.S. Provisional Patent Application Ser. No. 61/948,886, which was filed in the U.S. Patent and Trademark Office on Mar. 6, 2014, the entire disclosure of which is incorporated herein by reference.

### BACKGROUND OF THE INVENTION

1. Field of the Invention

The present invention relates generally to a method and apparatus for wireless communication, and more particularly, to a method and apparatus which allows legacy devices and next-generation devices to coexist with each other within next-generation networks and also within Overlapping Basic Service Sets (OBSS) of multiple networks, e.g., next-generation networks and legacy networks.

2. Description of the Related Art

The development of next-generation High Efficiency Wireless (HEW) communication networks, e.g., next-generation networks, and the devices, e.g., both Access Points (APs) and Stations (STAs), configured for use in such communication networks is on the rise. A primary focus when developing such communication networks is to increase an efficiency in which the next-generation networks can operate, such as in a situation where there are many devices, both APs and STAs, within range of each other but not necessarily all part of the next-generation network. That is, some of the APs and STAs can be next-generation devices, while others can be legacy devices that are operable over a legacy network, or a next-generation network, i.e. legacy STAs can use a next-generation AP (and legacy APs can support next-generation STAs).

However, the legacy devices, which may not have been developed with the next-generation technology in mind, may not work as well, if at all, in the next-generation communication networks. For example, transmissions associated with the legacy devices with the next-generation communication network may decrease efficiency of the next-generation communication networks, which, in turn, may result in degradation in a quality of experience provided to users of the next-generation devices and/or legacy devices.

Therefore, there exists a need for a method and apparatus which allows legacy and next-generation devices to coexist with one another within next-generation wireless networks.

### SUMMARY OF THE INVENTION

The present invention has been made to address the above problems and disadvantages, and to provide at least the advantages described below.

Accordingly, an aspect of the present invention is to provide a method and apparatus which allows legacy and next-generation devices to coexist with one another within next-generation wireless networks, which may prove useful in wireless telecommunication.

Another aspect of the present invention is to provide a mechanism by which next-generation devices will be able to influence legacy devices so as to mitigate the performance degradation caused by the legacy devices.

More particularly, an aspect of the present invention is to provide next-generation devices with the capability of generating and transmitting quietening frames, which are interpreted by the next-generation devices according to a first set of rules and by the legacy devices according to a second set of rules. Specifically, the legacy devices interpret the quietening frame as an indication that a transmission medium is busy for a specific time interval, while the next-generation devices interpret the quietening frame as an indication that the legacy devices are not transmitting for a certain time interval, thus allowing the next-generation devices to continue to use the transmission medium without interference by legacy devices.

In accordance with an aspect of the present invention, a method for communication over a wireless medium is provided. The method includes transmitting a signal over the wireless medium. The signal includes at least one frame that is formatted for interpretation by a first device and a second device. Transmission of at least one of the first device and the second device is interrupted based on an interpretation of the at least one frame.

In accordance with another aspect of the present invention, a method for communication over a wireless medium is provided. The method includes receiving, at a first device and a second device, a signal over the wireless medium. The signal includes at least one frame that is formatted for interpretation by the first device and the second device. A transmission function of at least one of the first device and the second device is interrupted based on an interpretation of the at least one frame.

In accordance with another aspect of the present invention, a system for communicating over a wireless medium is provided. The system includes a STA including at least one processor configured to transmit a signal over the wireless medium. The signal includes one or more frames that are formatted for interpretation by a first device and a second device, wherein a transmission function of at least one of the first device and the second device is interrupted based on an interpretation of the at least one frame.

In accordance with yet another aspect of the present invention, a new-generation transceiver for communicating over a wireless medium is provided. The new-generation transceiver includes at least one processor that is configured to receive a signal over the wireless medium. The signal includes at least one frame formatted to interrupt a transmission function of legacy transceivers. The at least one processor is configured to determine if the at least one frame should be interpreted according to a first set of rules corresponding to the new-generation transceiver, wherein, if the at least one processor determines that the at least one frame should be interpreted according to the first set of rules, the at least one processor allows transmission by the new-generation transceiver.

In accordance with another aspect of the present invention, a sniffer is provided. The sniffer includes at least one processor configured to detect a signal over a wireless medium. The signal including at least one frame formatted for interpretation by a first device and a second device, wherein a transmission function of at least one of the first device and the second device is interrupted based on an interpretation of the at least one frame.

In accordance with another aspect of the present invention, a computer-readable medium having stored thereon a plurality of executable instructions is provided. The plurality of instructions include instructions to transmit a signal over a wireless medium, the signal including at least one frame formatted for interpretation by a first device and a second device, wherein a transmission function of at least one of the first device and the second device is interrupted based on an interpretation of the at least one frame.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram of a system for communicating over a wireless medium, according to an embodiment of the present invention;

FIG. 2 is a diagram illustrating the components of the STAs shown in FIG. 1, according to an embodiment of the present invention;

FIG. 3 is a signaling diagram illustrating a signaling sequence between three of the STAs shown in FIG. 1, according to an embodiment of the present invention;

FIG. 4 is a flowchart illustrating a method for communication over a wireless medium, according to an embodiment of the present invention; and

FIG. 5 is a flowchart illustrating a method for communication over a wireless medium, according to another embodiment of the present invention.

### DETAILED DESCRIPTION OF EMBODIMENTS OF THE PRESENT INVENTION

Various embodiments of the present invention will now be described in detail with reference to the accompanying drawings. In the following description, specific details such as detailed configuration and components are merely provided to assist in the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

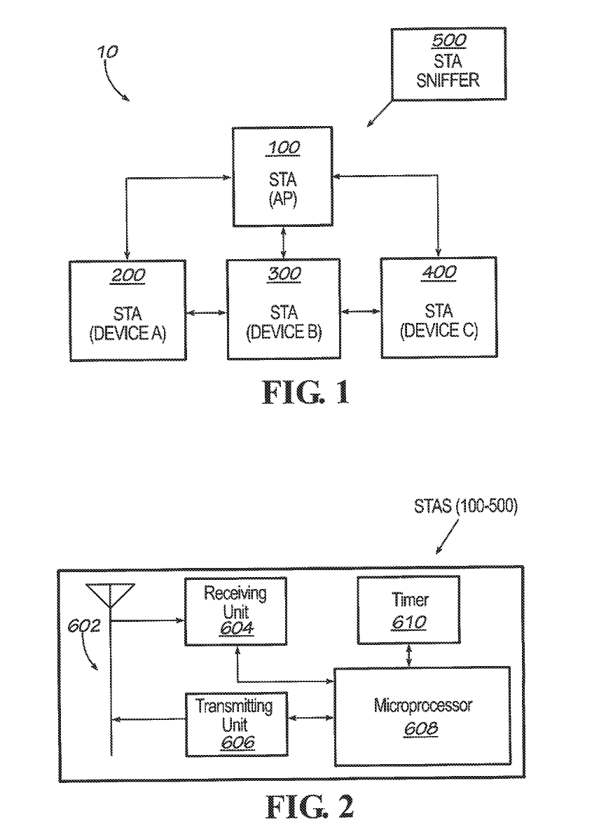

FIG. 1 illustrates a wireless communication network 10 (network 10), according to an embodiment of the present invention. The network 10 includes a plurality of STAs that are capable of communicating over the network 10. For illustrative purposes, the plurality of STAs is shown including a STA 100, e.g., an AP or base STA, and a plurality of associated user STAs 200, 300, 400, e.g., DEVICES A-C. The individual user STAs 200, 300, 400 may be embodied in the form of a cell phone, a Personal Digital Assistant (PDA), a laptop, a workstation, a personal computer, a video camcorder, etc. As can be appreciated, one or more of the user STAs 200, 300, and 400 can be embodied as another AP. Moreover, it is contemplated that the AP can also be component of a larger system or device, rather than being a dedicated AP.

One or more STAs 500 may be embodied in a form of a sniffer (FIG. 1) and may be implemented in the network 10, as will be described in more detail below.

While the AP 100 will be described herein as the transmitting device and the user STAs 200, 300, 400 as the receiving devices, it will be understood by those skilled in the art that both the AP 100 and STAs 200, 300, 400 can each receive and transmit signals over the network 10.

Moreover, it should be appreciated that the user STAs 200, 300, 400 may be connected to other devices and/or networks with which the STAs may communicate. Further, though FIG. 1 shows five stations within the network 10, it should be appreciated that the network 10 may include more or fewer than five stations.

The network 10 can operate under one or more of the IEEE 802.11 standards such as the IEEE 802.11n, IEEE 802.11ac and IEEE 802.11a/b/g standards. However, other IEEE 802.11 standards are contemplated.

For illustrative purposes, the user STAs 200, 300 are described herein as next-generation devices, i.e., the STAs 200, 300 are configured for communicating over foreseeable new IEEE wireless standards, e.g., the IEEE 802.11ax wireless standard, and the user STA 400 is described herein as a legacy device, i.e., STA 400 is configured for communicating over the IEEE 802.11a/b/g/n/ac wireless standard.

The STA 100 is described herein as a next-generation device and is capable of communicating with other next-generation devices and legacy devices within the network 10. In other words, the STA 100 is capable of communicating with the user STAs 200, 300, 400 according to the IEEE 802.11ax wireless standard and the IEEE 802.11a/b/g/n/ac wireless standard.

FIG. 2 is a diagram illustrating an example of an embodiment of the components that may be provided in each of the STAs 100-500 in the network 10. As shown in FIG. 2, each of the STAs 100-500 is provided with at least one antenna 602, a receiving unit 604, a transmitting unit 606, at least one microprocessor (μp) 608, and a timer 610. These components allow the STAs 100-500 to selectively transmit and receive signals within the network 10. As can be appreciated, the timer can be omitted and a clock of the STAs may be used to instead.

When receiving data, a signal received by the STAs 100-500 is received by the antenna 602 and demodulated into control information or data through the receiving unit 604. Based on this control information, the μp 608 controls the transmission of data from the STA. Specifically, the μp 608 processes the received control information to determine if the wireless medium is busy. If the μp 608 determines that the wireless medium is busy, the μp 608 proceeds to defer mode in which the STA will not transmit for a predetermined time interval, while if μp 608 determines that the wireless medium is not busy (or unused), the transmitting unit 606 will proceed to transmit data for a predetermined time interval.

In accordance with the embodiments of the present invention, to increase the efficiency at which the network 10 may operate, the μp 608 associated with the STA 100 is configured transmit a signal which includes at least one frame, e.g., a quietening frame 102, that is formatted for interpretation according to a first set of rules, i.e., next-generation rules, and a second set of rules, e.g., legacy rules. The next-generation rules correspond to next-generation receiving devices such as the STAs 200, 300 and the legacy rules correspond to legacy receiving devices such as the STA 400.

Accordingly, when the STAs 200, 300 receive the quietening frame 102, these STAs interpret the quietening frame 102 according to the first set of rules, which, in turn, causes the μp 608 associated with these STAs to consider the wireless medium not busy. In this instance, a transmission function of the STAs 200, 300 is not interrupted and these STAs are permitted to transmit over the network 10. Conversely, when the STA 400 receives the quietening frame 102, this STA interprets the quietening frame 102 according to the second set of rules, which, in turn, causes the μp 608 associated with this STA to consider the wireless medium busy. In this instance, a transmission function of the STA 400 is interrupted and this STA is not permitted to transmit over the network 10 for a predetermined time interval, which can be a fixed time interval, e.g., determined by a manufacturer and stored in the STA 100 or determined at the time in which the STA 100 generates the quietening frame 102.

Information relating to the predetermined time interval in which the STA 400 considers the wireless medium busy may be transmitted within the quietening frame 102 of the received signal (or another frame of the signal, such as the frames described below).

Moreover, the predetermined time interval in which the STA 400 considers the wireless medium busy may be determined in real-time by the μp 608 associated with the STA 100. For example, the μp 608 associated with the STA 100 may use parameters such as network traffic, a number of next-generation devices and legacy devices in the network 10, a generation of the legacy devices, etc., in determining the predetermined time interval in which the legacy device(s) in the network 10 is/are to consider the wireless medium busy. Alternatively, the predetermined time interval may be determined by a manufacturer during the manufacturing process of the STA 100, e.g., one second, two seconds, etc.

In the embodiments according to the present invention, the predetermined time interval at which the transmission function of the STA 400 is interrupted may begin upon reception of the quietening frame 102 at the STA 400. For example, according to the embodiments of the present invention, the timer 610 associated with the STA 400 is set by the μp 608 upon reception of the quietening frame 102. Once the timer 610 of the STA 400 has expired, i.e., after the predetermined time interval, and if another quietening frame 102 has not been received by the STA 400, the STA 400 transmission function interruption is terminated and the STA 400 is allowed to transmit over the network 10 to the STA 100.

If, during the predetermined time interval or at any time thereafter, the μp 608 of the STA 100 determines that another quietening frame 102 should be sent, e.g., high network traffic and/or upon expiration of the timer 610 (which may be set upon transmission of the quieting frame 102) of the μp 608 of the STA 100, then a subsequent quietening frame 102 may be sent to the STA 400 to interrupt the transmission function of the STA 400.

In accordance with the embodiments of the present invention, the quietening frame 102 can be embodied in various forms including, but not limited to, a frame indicating a length in a PHYSICAL (PHY) header, e.g. long length and low rate in a SIGNAL (SIG) field associated with the IEEE 802.11a/b/g wireless standard (or the equivalent in a HIGH THROUGHPUT (HT)-SIG or VERY HIGH THROUGHPUT (VHT)-SIG field associated with the IEEE 802.11n and IEEE 802.11ac wireless standards, respectively), a frame indicating a long duration of subsequent transmissions in a Medium Access Control (MAC) header, a Quiet element in a Beacon frame in the IEEE 802.11a/b/g/n wireless standard (or the equivalent in the IEEE 802.11ac wireless standard), a Clear-To-Send (CTS) frame (or a Request-To-Send (RTS) frame), and a Contention-Free-End (CF-End) frame.

As can be appreciated, the specific form in which the quietening frame 102 embodies may depend on the specific IEEE wireless standard in which the μp 608 associated with the STA 100 is configured to transmit.

In accordance with the embodiments of the present invention, an indication to next-generation devices, e.g., the STAs 200, 300, that the quietening frame 102 is directed specifically to the legacy devices, e.g., STA 400, could take many forms including, but not limited to, setting a currently reserved bit in the IEEE 802.11a/b/g SIGNAL field (or the SERVICE field), clearing a currently reserved bit in the IEEE 802.11n HT-SIG field, clearing one of three currently reserved bits in the IEEE 802.11ac VHT-SIG-A field, setting a currently reserved bit in the MAC header, e.g. bit 7 of the Quality of Service (QoS) control field of the QoS Null frames is currently reserved. Bits of other reserved fields can also be set/cleared to indicate to the next-generation devices that the quietening frame 102 is specifically directed to the legacy devices. For example, bits such as the power management field of a Frame Control Field of Beacon frames (FCFoBf), the More Frag field (MFf), Retry field (Rf) and Protected Frame field (PFf), and Order fields (Of) of the FCF of Control frames (Cf) can also be set/cleared to indicate to the next-generation devices that the quietening frame 102 is specifically directed to the legacy devices.

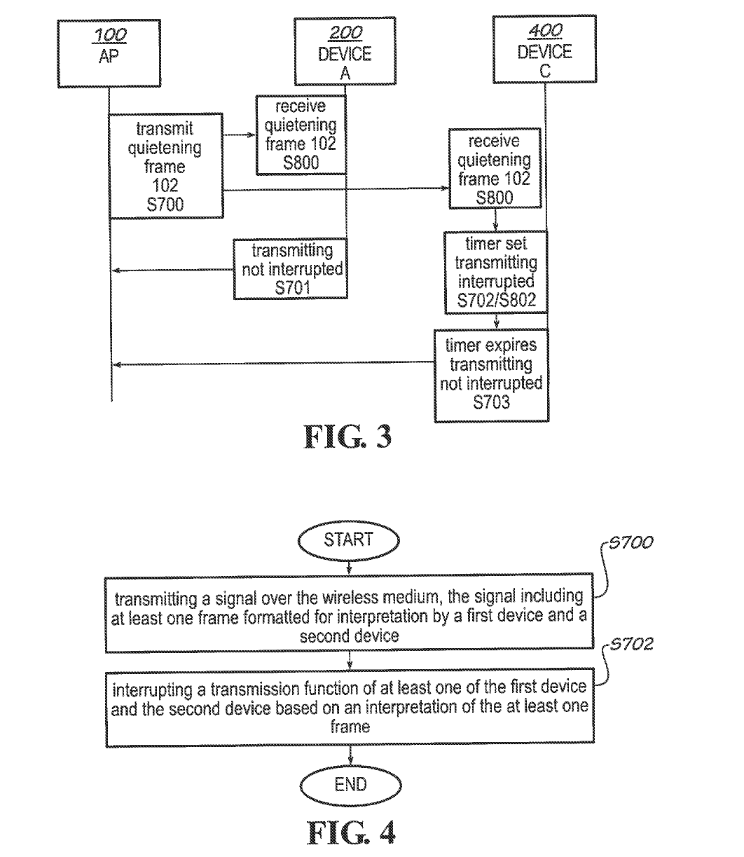

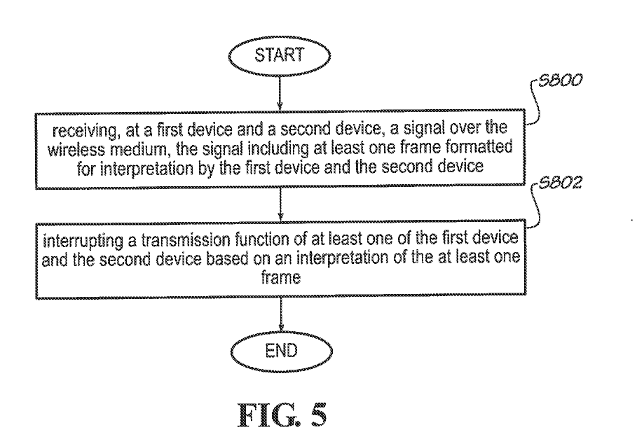

FIG. 3 is a signaling diagram illustrating a signaling sequence between the STAs 100, 200, and 400, according to an embodiment of the present invention, and FIGS. 4 and 5 are methods for communication over a wireless medium, according to embodiments of the present invention.

Referring to FIGS. 3-5, the STA 100 transmits a signal including the quietening frame 102, at step S700 of FIG. 4, which is received by STAs 200 and 400, at step S800 of FIG. 5.

As noted above, the STA 200, which is a next-generation device, interprets the quietening frame 102 according to next-generation rules. That is, the STA 200 considers the wireless medium not busy and transmits signals, e.g., data, over the network 10 to the STA 100 and/or another STA in the network, e.g., STA 300 (FIG. 3).

Conversely, the STA 400, which is a legacy device, interprets the quietening frame 102 according to the legacy rules, at steps S702/S802 of FIGS. 4 and 5, respectively. That is, the STA 400 considers the wireless medium busy and refrains from transmitting over the network 10.

As described above, the STA 400 refrains from transmitting over the network 10 for a predetermined time interval that begins when the quietening frame 102 is received at the STA 400 and the timer 610 of the STA 400 is set (FIG. 3).

Upon expiration of the timer 610 of the STA 400, and if another quietening frame 102 has not been received by the STA 400, the STA 400 transmission function interruption is terminated and the STA 400 is allowed to transmit over the network 10 to the STA 100 (FIG. 3).

If, during the predetermined time interval or at any time thereafter, the μp 608 of the STA 100 determines that another quietening frame 102 should be sent, e.g., high network traffic, then a subsequent quietening frame 102 may be sent to the STA 400 to interrupt the transmission function of the STA 400.

The methods and apparatus according to the embodiments of the present invention, allow next-generation devices, e.g., STAs 200, 300, and legacy devices, e.g., STA 400, to coexist in the same network 10 without decreasing the efficiency of the network 10. That is, the transmissions associated with legacy devices, e.g., STA 400, do not decrease efficiency of the network 10, as such transmissions are not permitted or are limited when the next-generation devices, e.g., STAs 200, 330, are transmitting, which, in turn, may increase a quality of experience provided to user of the next-generation STAs (or devices) and/or the legacy STAs (or device)(s) 400.

While the present invention has been described herein with the STAs 100-400 being within the same network, the invention is not so limited. For example, the present invention is equally applicable to cover overlapping networks. In such an instance, a quietening frame 102 may be sent by the STA 100, which may be located in network 10, to the STA 400, which may be located in neighboring network that overlaps network 10, to interrupt the transmission function of STA 400 in the neighboring network. Once the STA 400 receives the quietening frame 102, the quietening frame 102 performs the functions described above.

While the present invention has been described herein such that sole purpose of the quietening frame 102 is to interrupt a transmission function of legacy STAs, e.g. a QoS Null frame which isn't also an Unscheduled-Automatic Power Save Delivery (U-APSD) trigger or Power Management mode indicator, it is in the purview of the present invention that the quietening frame 102 be used to perform other functions. For example, it may prove advantageous, on the grounds of efficiency, for the quietening frame 102 to carry information that can be used for performing a specific function, e.g. a Beacon, or QoS Data frame, or QoS Null frame which is a U-APSD trigger.

As noted above, the network 10 may also include a STA 500 that is embodied in the form of a sniffer (FIG. 1). The STA 500, or packet analyzer, can be used in the network 10 to intercept and log traffic passing over the network 10. The STA 500 may be implemented in hardware or software. As data streams flow across the network 10, the STA 500 can be configured to capture data and, if needed, decode and analyze their content or provide the captured data to an analyzing tool for further processing. The captured data may for instance be analyzed to obtain information about the network 10 or the communication, e.g. to debug the communication or to diagnose problems of the network 10.

Accordingly, in accordance with another embodiment of the present invention, the STA 500 is embodied in the form of a sniffer for communicating over a wireless medium and includes at least one processor that is configured to detect a signal over a wireless medium. The signal includes at least one quietening frame formatted for interpretation by a first device and a second device, wherein a transmission function of at least one of the first device and the second device is interrupted based on an interpretation of the at least one frame.

The present invention or aspects thereof are capable of being distributed in the form of a non-transitory computer-readable program product stored in a tangible computer medium having stored thereon a plurality of executable instructions. The plurality of executable instructions in a variety of forms for execution on a processor, processors, or the like, and the present invention applies equally regardless of the particular type of signal-bearing media used to actually carry out the distribution.

The plurality of instructions comprising instructions to: transmit a signal over a wireless medium, the signal including at least one frame formatted for interpretation by a first device and a second device, wherein a transmission function of at least one of the first device and the second device is interrupted based on an interpretation of the at least one frame.

The non-transitory computer readable program product can be in the form of microcode, programs, routines, and symbolic languages that provide a specific set or sets of ordered operations that control the functioning of the hardware and direct its operation, as known and understood by those skilled in the art. Examples of computer readable media include, but are not limited to: nonvolatile hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs. DVD-R/RWs, DVD+R/RWs, flash drives, memory sticks, HD-DVDs, mini disks, laser disks, Blu-ray disks, and other newer types of memories, and transmission type media such as digital and analog communication links.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method for communication over a wireless medium, the method comprising:
transmitting a signal over the wireless medium, the signal including at least one frame formatted for interpretation by a first device and a second device; and
interrupting a transmission function of at least one of the first device and the second device based on an interpretation of the at least one frame.

2. The method according to claim 1, wherein interrupting the transmission function of the at least one of the first device and the second device is maintained for a predetermined time interval that begins upon reception of the at least one frame.

3. The method according to claim 1, wherein the first device is a next-generation device and the second device is a legacy device.

4. The method according to claim 1, wherein the first device interprets the at least one frame according to a first set of rules and the second device interprets the at least one frame according to a second set of rules.

5. The method according to claim 4, wherein interpreting the at least one frame according to the first set of rules causes the first device to consider the wireless medium not busy and interpreting the at least one frame according the second set of rules interpretation causes the second device to consider the wireless medium busy.

6. The method according to claim 5, further comprising, prior to transmitting the signal, one of setting and clearing at least one bit in the at least one frame, wherein one of setting and clearing the at least one bit in the at least one frame indicates to the first device that the at least one frame is to be interpreted according to the first set of rules.

7. The method according to claim 1, wherein the at least one frame of the signal is one of a frame indicating a length in a PHYSICAL (PHY) header of the signal, a frame used to indicate a duration of subsequent transmissions in a MAC header of the signal, a Quiet element in a Beacon frame, a Clear-To-Send (CTS) frame or a Request-To-Send (RTS) frame of the signal, and a Contention-Free-End (CF-End) frame of the signal.

8. A method for communication over a wireless medium, the method comprising:
receiving, at a first device and a second device, a signal over the wireless medium, the signal including at least one frame formatted for interpretation by the first device and the second device; and
interrupting the transmission function of at least one of the first device and the second device based on an interpretation of the at least one frame.

9. The method according to claim 8, wherein interrupting the transmission function of at least one of the first device and the second device is maintained for a predetermined time that begins upon reception of the at least one frame.

10. The method according to claim 8, wherein the first device is a next-generation device and the second device is a legacy device.

11. The method according to claim 8, wherein the first device interprets the at least one frame according to a first set of rules and the second device interprets the at least one frame according to a second set of rules.

12. The method according to claim 11, wherein interpreting the at least one frame according to the first set of rules causes the first device to consider the wireless medium not busy and interpreting the at least one frame according the second set of rules interpretation causes the second device to consider the wireless medium busy.

13. The method according to claim 8, further comprising, prior to transmitting the signal, one of setting and clearing at least one bit in the at least one frame, wherein one of setting and clearing the at least one bit in the at least one frame indicates to the first device that the at least one frame is to be interpreted according to the first set of rules.

14. The method according to claim 8, wherein the at least one frame of the signal is one of a frame indicating a length in a PHYSICAL (PHY) header of the signal, a frame used to indicate a duration of subsequent transmissions in a MAC header of the signal, a Quiet element in a Beacon frame, a Clear-To-Send (CTS) frame or a Request-To-Send (RTS) frame of the signal, and a Contention-Free-End (CF-End) frame of the signal.

15. A system for communicating over a wireless medium, the system comprising:
a STATION (STA) including at least one processor configured to transmit a signal over the wireless medium, the signal including at least one frame formatted for interpretation by a first device and a second device,
wherein a transmission function of at least one of the first device and the second device is interrupted based on an interpretation of the at least one frame.

16. The system according to claim 15, wherein the interruption of the transmission function of the at least one of the first and second devices is maintained for a predetermined time that begins upon reception of the at least one frame.

17. The system according to claim 15, wherein the first device is a next-generation device and the second device is a legacy device.

18. The system according to claim 15, wherein the first device interprets the at least one frame according to a first set of rules and the second device interprets the at least one frame according to a second set of rules.

19. The system according to claim 18, wherein interpretation of the at least one frame according to the first set of rules causes the first device to consider the wireless medium not busy and interpretation of the at least one frame according the second set of rules causes the second device to consider the wireless medium busy.

20. The system according to claim 18, wherein the at least one processor is configured to one of set and clear at least one bit in the at least one frame, wherein one of a set and a cleared at least one bit in the at least one frame indicates to the first device that the at least one frame is to be interpreted according to the first set of rules.

21. The system according to claim 15, wherein the at least one frame of the signal is one of a frame indicating a length in a PHYSICAL (PHY) header of the signal, a frame used to indicate a duration of subsequent transmissions in a MAC header of the signal, a Quiet element in a Beacon frame, a Clear-To-Send (CTS) frame or a Request-To-Send (RTS) frame of the signal, and a Contention-Free-End (CF-End) frame of the signal.

22. A new-generation transceiver for communicating over a wireless medium, the new-generation transceiver comprising:
at least one processor configured to receive a signal over the wireless medium, the signal including at least one frame formatted to interrupt a transmission function of legacy transceivers, and to determine if the at least one frame should be interpreted according to a first set of rules corresponding to the new-generation transceiver,
wherein, if the at least one processor determines that the at least one frame should be interpreted according to the first set of rules, the at least one processor allows transmission by the new-generation transceiver.

23. A sniffer for communicating over a wireless medium, the sniffer comprising:
at least one processor configured to detect a signal over a wireless medium, the signal including at least one frame formatted for interpretation by a first device and a second device,
wherein a transmission function of at least one of the first device and the second device is interrupted based on an interpretation of the at least one frame.

24. A non-transitory computer-readable medium having stored thereon a plurality of executable instructions, the plurality of instructions comprising instructions to:
transmit a signal over a wireless medium, the signal including at least one frame formatted for interpretation by a first device and a second device,
wherein a transmission function of at least one of the first device and the second device is interrupted based on an interpretation of the at least one frame.
